(19) United States
(12) Patent Application Publication
(10) Pub. No.: US 2026/0307146 A1
(43) Pub. Date: Oct. 8, 2026

(54) SINTERING DEVICES, SINTERING ASSEMBLIES, AND ASSOCIATED METHODS

(71) Applicants: Idaho State University, Pocatello, ID (US); Battelle Energy Alliance, LLC, Idaho Falls, ID (US)

(72) Inventors: Andrew J. Gorman, Rigby, ID (US); Mark E. Small, Shelley, ID (US); Robert V. Fox, Idaho Falls, ID (US); Anthony P. D'Andrea, Iona, ID (US); Jorgen F. Rufner, Idaho Falls, ID (US); Troy B. Holland, New Albany, IN (US); Golam Gause Jaman, Pocatello, ID (US); Kanan R. Chowdhury, Indianapolis, IN (US); Marco Schoen, Pocatello, ID (US)

(21) Appl. No.: 19/484,683

(22) PCT Filed: May 14, 2024
(86) PCT No.: PCT/US2024/029327

§ 371 Date: Nov. 14, 2025

Related U.S. Application Data
(60) Provisional application No. 63/502,358, filed on May 15, 2023.

(51) Int. Cl. B22F 3/00; B22F 3/105; F27B 7/00

(52) U.S. Cl. CPC B22F 3/003; B22F 3/105; F27B 7/00; B22F 2202/06; B22F 2203/00

(57) ABSTRACT

A sintering device comprising at least two rollers spaced apart and defining a sintering space therebetween. Each roller comprises an electrically conductive outer ring and at least two brushes disposed on each of the at least two rollers and configured to pass an electric current through the electrically conductive outer rings of each of the at least two rollers. A sintering assembly comprises the sintering device and an enclosure operatively connected to the sintering device. The at least two rollers of the sintering device are configured to receive a feedstock from an inlet of the enclosure and configured to produce a sintered product to an outlet of the enclosure. Methods of sintering a feedstock are also disclosed.

### CROSS-REFERENCE TO RELATED APPLICATIONS

This application is a national phase entry under 35 U.S.C. § 371 of International Patent Application PCT/US 2024/029327, filed May 14, 2024, designating the United States of America and published as International Patent Publication WO 2024/238576 A 1 on Nov. 21, 2024, which claims the benefit under Article 8 of the Patent Cooperation Treaty of U.S. Provisional Patent Application Ser. No. 63/502,358, filed May 15, 2023, for “SINTERING ASSEMBLIES AND ASSOCIATED METHODS,” the disclosure of each of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure relates generally to sintering assemblies and related methods. More particularly, the disclosure relates to continuous electric-field-assisted sintering assemblies and associated methods.

### BACKGROUND

Electric-field-assisted sintering (EFAS) can be used to produce articles through batch processes. The batch processes conventionally utilize a die to form articles by applying uniaxial forces and current to heat a material in the die and form the articles. Conventional EFAS systems typically facilitate production of one to five articles depending on the configuration of the die. After the EFAS process has been conducted, the articles are removed from the die and the process is repeated to produce additional articles.

### BRIEF SUMMARY

Some embodiments of the disclosure include a sintering device that comprises at least two rollers spaced apart and defining a sintering space therebetween. Each roller comprises an electrically conductive outer ring and at least two brushes disposed on each of the at least two rollers. The at least two brushes are configured to pass an electric current through the electrically conductive outer rings of each of the at least two rollers.

Another embodiment of the disclosure includes a sintering assembly that comprises a sintering device and an enclosure operatively connected to the sintering device. The sintering device comprises at least two rollers comprising an electrically conductive outer ring and at least two brushes contacting the at least two rollers. The at least two brushes are configured to pass an electric current through each outer ring. The at least two rollers of the sintering device are configured to receive a feedstock from an inlet of the enclosure and configured to produce a sintered product to an outlet of the enclosure.

Another embodiment of the disclosure includes a method of sintering a feedstock. The method comprises introducing a feedstock to a sintering device. The sintering device comprises at least two rollers spaced apart and defining a sintering space therebetween. Each roller comprises an electrically conductive outer ring and at least two brushes disposed on each of the at least two rollers and configured to pass an electric current through the electrically conductive outer rings of each of the at least two rollers. The feedstock is continuously passed into the sintering space between the at least two rollers of the sintering device. The at least two rollers are positioned to contact the feedstock. An electric current is applied across the at least two rollers through the at least two brushes, the electric current resistively heating the at least two rollers. Heat is transferred to the feedstock from the at least two rollers to produce a sintered product.

### BRIEF DESCRIPTION OF THE DRAWINGS

FIG. 1 is a perspective view of a continuous electric-field-assisted sintering (CEFAS) assembly in accordance with embodiments of the disclosure;

FIG. 2 is a perspective view of a CEFAS device in accordance with embodiments of the disclosure;

FIG. 3 is a perspective view of a CEFAS device in accordance with embodiments of the disclosure;

FIG. 4 is a perspective view of a CEFAS device in accordance with embodiments of the disclosure;

FIG. 5 is an elevational cross section of a CEFAS device in accordance with embodiments of the disclosure;

FIG. 6 is a perspective view of a roller of the CEFAS device in accordance with embodiments of the disclosure;

FIG. 7 is a perspective view of the roller of FIG. 6, in accordance with embodiments of the disclosure;

FIG. 8 is a schematic view of a power supply connected to rollers of the CEFAS device in accordance with embodiments of the disclosure;

FIG. 9 is an elevational cross section of a CEFAS device in accordance with embodiments of the disclosure; and

FIG. 10 is a flowchart of a control system in accordance with embodiments of the current disclosure.

### DETAILED DESCRIPTION

In the detailed description, the claims, and the accompanying drawings, reference is made to particular features (including method acts) of the disclosure. It is to be understood that the disclosure includes all possible combinations of such features. For example, where a particular feature is disclosed in the context of a particular embodiment, or a particular claim, that feature may also be used, to the extent possible, in combination with and/or in the context of other aspects and embodiments described herein.

The following description provides specific details, such as components, assemblies, and materials in order to provide a thorough description of embodiments of the disclosure. However, a person of ordinary skill in the art will understand that the embodiments of the disclosure may be practiced without employing these specific details.

The use of the term “for example,” means that the related description is explanatory, and though the scope of the disclosure is intended to encompass the examples and legal equivalents, the use of such terms is not intended to limit the scope of an embodiment or this disclosure to the specified components, acts, features, functions, or the like.

Drawings presented herein are for illustrative purposes and are not necessarily meant to be actual views of any particular material, component, structure, or device. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the term “configured to” in reference to a structure or device intended to perform some function refers to size, shape, material composition, material distribution, orientation, and/or arrangement, etc., of the referenced structure or device.

As used herein, the terms “comprising” and “including,” and grammatical equivalents thereof are inclusive or open-ended terms that do not exclude additional, unrecited elements or method acts, but also include the more restrictive terms such as “consisting of” and “consisting essentially of” and grammatical equivalents thereof.

As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

As used herein, the singular forms “a,” “an,” and “the” include the plural forms as well, unless the context clearly indicates otherwise.

As used herein, the term “and/or” includes any and all combinations of one or more of the associated listed items.

As used herein, relational terms, such as “first,” “second,” etc., are used for clarity and convenience in understanding the disclosure and accompanying drawings and does not connote or depend on any specific preference, orientation, or order, except where the context clearly indicates otherwise.

As used herein, the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

While embodiments of this disclosure have been described and illustrated herein with respect to specific sintering devices, those of ordinary skill in the art will recognize and appreciate that features and elements from different embodiments may be combined to arrive at further, additional types of sintering devices and methods as contemplated by the inventors.

Electric-field-assisted sintering (EFAS) can be used to produce articles through batch processes. However, the batch processes are conventionally limited to producing between one and five articles. Batch production with EFAS systems tends to increase the production time of the articles, utilizes higher temperatures, and is limiting on dimensions of the produced articles. Due to these factors, conventional EFAS systems have limited applications as the scale of article production is increased.

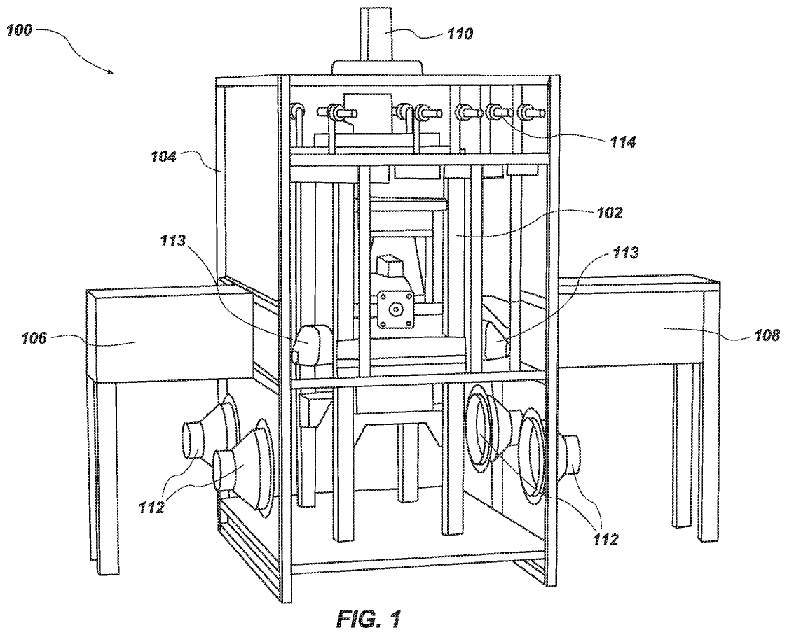

FIG. 1 shows an example of a continuous electric-field-assisted sintering (CEFAS) assembly 100 (e.g., a sintering assembly) including a CEFAS device 102 (e.g., a sintering device) and an enclosure 104. The CEFAS device 102 is configured to facilitate continuous production of the sintered product. The CEFAS device 102 may be contained within the enclosure 104. The enclosure 104 may be operatively connected to the CEFAS device 102.

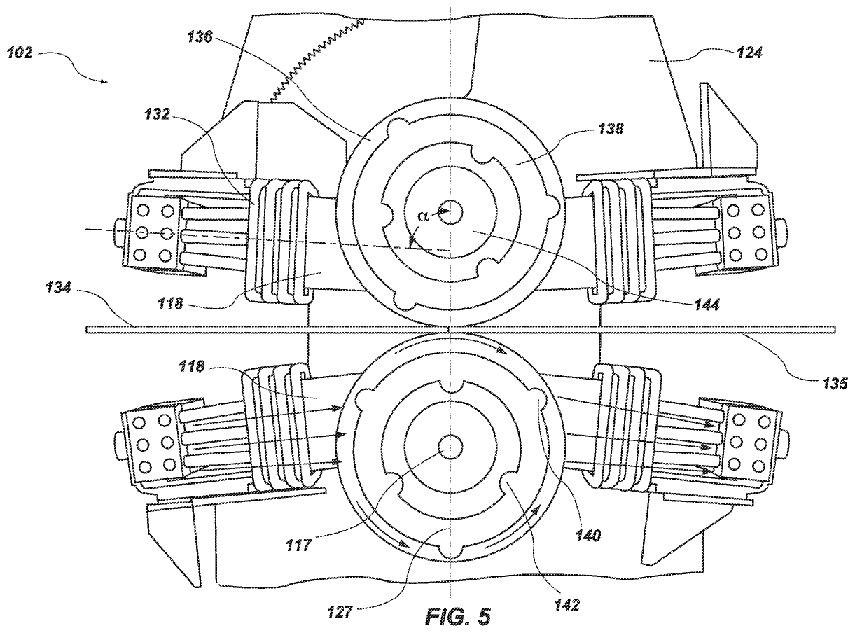

Overall dimensions and output of the CEFAS device 102 may be determined based on the size and type of element (e.g., sintered product) to be produced. The CEFAS device 102 may be configured for continuous production which differs from that of a conventional EFAS system which utilizes batch production. This change in production facilitates continuous production of the sintered product and facilitates the formation of sintered products having a high aspect ratio and a greater length than those produced by a conventional EFAS system. Rollers 116 of the CEFAS device 102 may facilitate the production of the sintered product at any desired length. The CEFAS device 102 may be configured to receive a feedstock 134 (see FIG. 5) that is formed of and includes one or more conductive or nonconductive materials. The feedstock 134 may be configured as a sample (e.g., material) that includes an elongated body, tape cast materials, plates, wires, and/or powder and may also include one or more layers. During operation of the CEFAS device 102, an electrical current and pressure are applied to the feedstock 134 which may sinter the feedstock 134. The feedstock 134 may, for example, include one or more metallic material, ceramic material, composite material, polymer material, green body, or a combination thereof. The metallic material may include, for example, steel, titanium, refractory metals, high entropy alloys, oxide dispersion-strengthened alloys, nickel-based alloys, or combinations thereof. The ceramic material may include one or more zirconia-based material, a yttrium oxide material, alumina, a nitride material, or a combination thereof. The composites may include one or more cermet, solid oxide electrolyzer cell, solid oxide fuel cell, ceramic metal composite, metal matrix composite, fiber reinforced composite, or a combination thereof. In some embodiments, the feedstock 134 is a perovskite material. The CEFAS device 102 is configured to receive the feedstock 134 having a thickness within a range from about 0.1 mm to about 150 mm. In some embodiments, the thickness of the feedstock 134 may be greater than about 150 mm. Changing the dimensions of the rollers 116 may facilitate changing the dimensions of the feedstock 134 that the CEFAS device 102 is configured to receive. For example, larger diameter and/or width of the rollers 116 may facilitate a larger width and/or thickness of the feedstock 134. The rollers 116 are discussed in greater detail below.

The enclosure 104 includes an inlet 106 for the feedstock 134 and an outlet 108 for the sintered product 135. The inlet 106 is configured to receive the feedstock 134 and direct the feedstock 134 through the CEFAS device 102. As the feedstock 134 passes through the CEFAS device 102, the feedstock 134 becomes a processed material (e.g., the sintered product) exhibiting desired material properties. The outlet 108 is configured to receive the sintered product 135 from the CEFAS device 102 and to allow the sintered product 135 to exit the enclosure 104. The inlet 106 and outlet 108 may be at least substantially aligned in an axial direction relative to each other. The feedstock 134 may be fed through the CEFAS device 102 by a motor that operates independently of the CEFAS device 102. The motor may be configured to move the feedstock 134 into the inlet 106, through the CEFAS device 102, and out of the outlet 108. In some embodiments, the feedstock 134 may be drawn through the CEFAS device 102 by the rollers 116, which are configured to move the feedstock 134 into the inlet 106, through the CEFAS device 102, and out of the outlet 108. The processing speed of the CEFAS device 102 may be within a range from about 0.01 in/min to about 15 in/min (0.254 cm/min to about 38.1 cm/min).

The CEFAS device 102 may operate at a lower temperature than conventional EFAS systems. For example, when processing a metallic, ceramic, or composite material, conventional EFAS systems may operate at temperatures up to about 2500 °C whereas the CEFAS device 102, according to embodiments of the disclosure, may operate at a temperature up to about 1650 °C, to form a substantially similar product. The operating temperature of the CEFAS device 102 may differ depending on the material composition of the feedstock 134. For example, if the feedstock 134 comprises one or more polymers, the CEFAS device 102 may be operated in a temperature range from about 25 °C to about 300 °C, If the feedstock 134 comprises one or more metallics, ceramics, or composite materials, the CEFAS device 102 may operate in a temperature range from about 200 °C to about 3000 °C or from about 200 °C to about 1650 °C. The enclosure 104 may also include one or more temperature control systems.

Pyrometers 113 may be configured to monitor the temperature of various portions of the CEFAS device 102. The enclosure 104 may include an input fan 110 and exhaust vents 112. The input fan 110 may be configured to circulate air through the enclosure 104 and out the exhaust vents 112. The circulation of air may help regulate the temperature within the enclosure 104, as well as remove contaminants, debris, fumes, or other byproducts of the CEFAS process from the enclosure 104. The exhaust vents 112 may include filters to facilitate containment of the contaminants, debris, fumes, or other byproducts. The enclosure 104 may also include a cooling system, such as liquid cooling system 114. The liquid cooling system 114 may be configured to circulate liquid from outside the enclosure 104, through the enclosure 104, and around and/or through the CEFAS device 102. The liquid cooling system 114 may be a closed system or may draw fluid from an external source. The liquid cooling system 114 may be configured to circulate water, another fluid coolant, or a combination of multiple fluids. In some embodiments, there may be multiple cooling systems that may operate independently from one another. The liquid cooling system 114 may be configured to circulate the fluid within the system at a temperature of from about −15 °C to about 65 °C, such as at about 18 °C. In some embodiments, the components of the CEFAS device 102 being cooled and the type of liquid in the liquid cooling system 114 may facilitate the operating temperature of the fluid being higher or lower than 18 °C

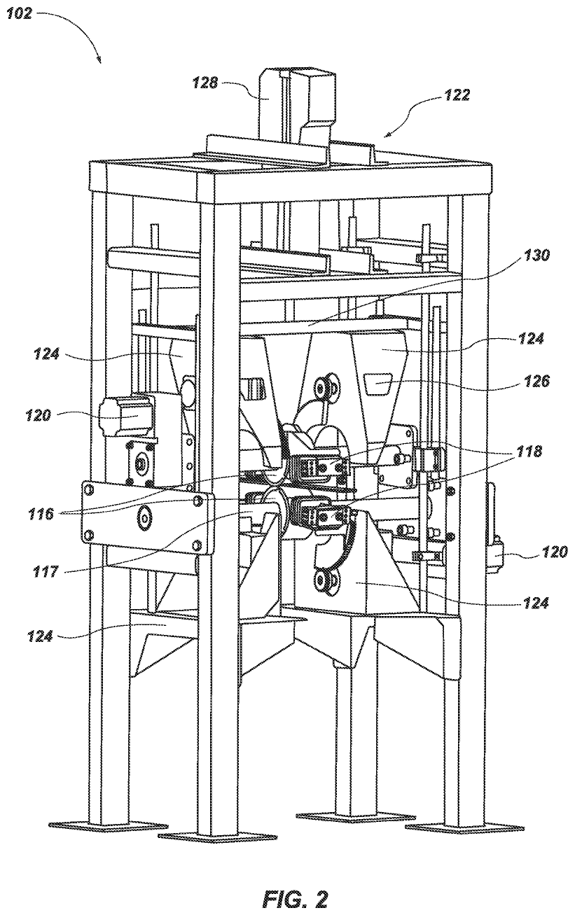

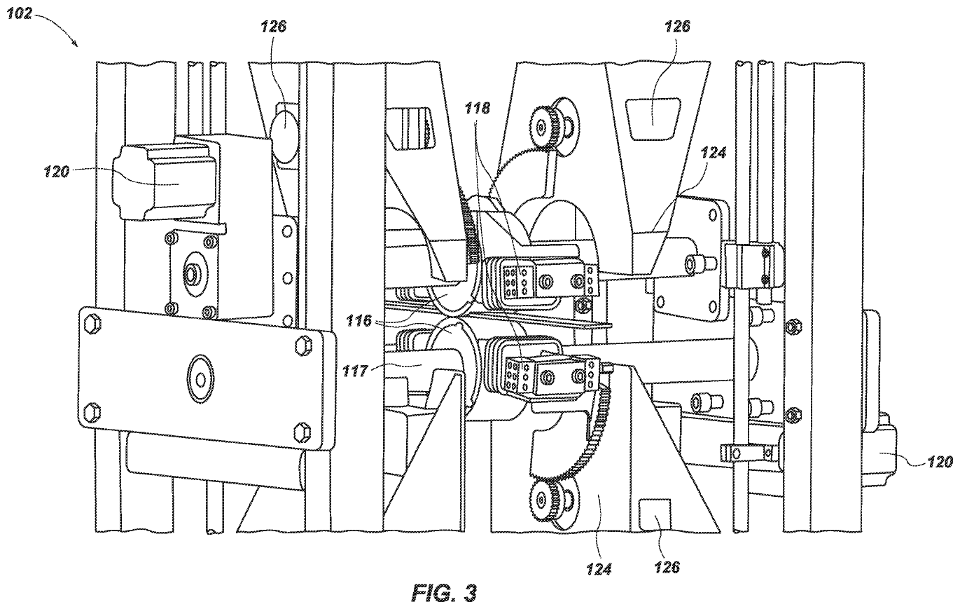

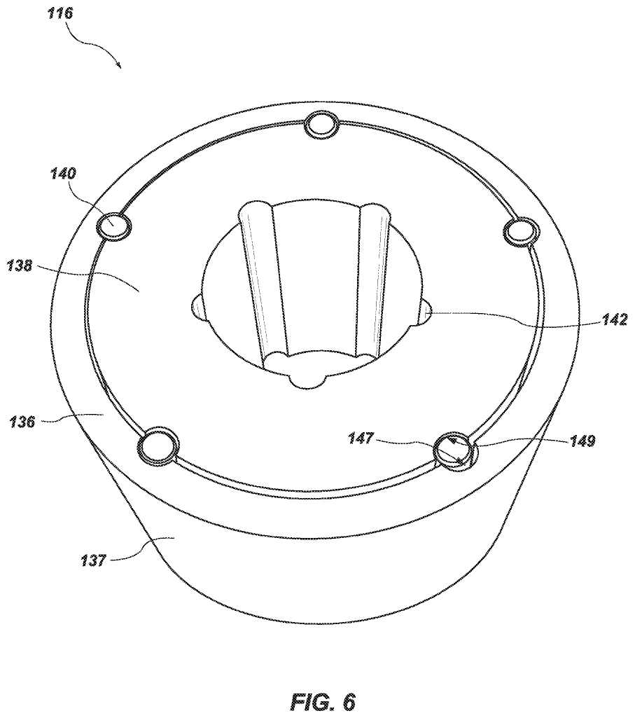

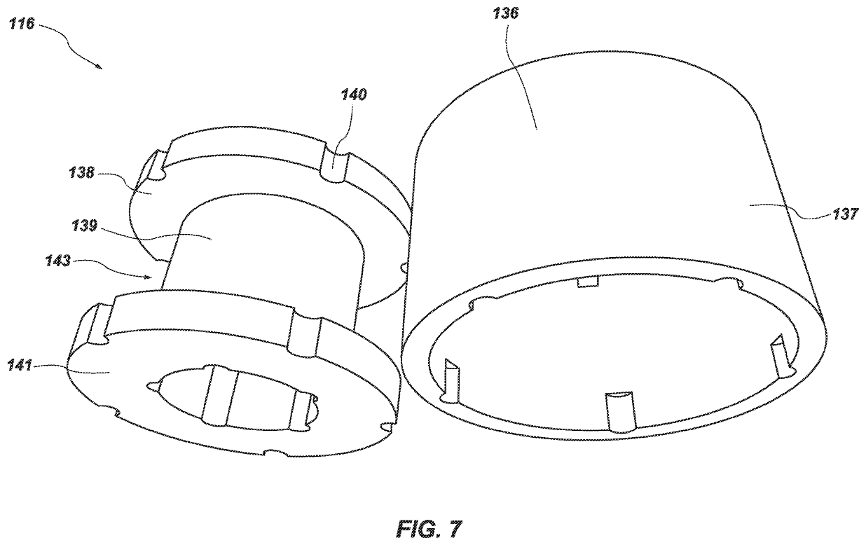

FIGS. 2 and 3 show perspective views of the CEFAS device 102. The CEFAS device 102 may include rollers 116, shafts 117, brushes 118, motors 120, and a positioning system 122. The CEFAS device 102 may, for example, include two rollers 116. The rollers 116 are described in greater detail below with regard to FIGS. 6 and 7. The rollers 116 may be operatively connected to the motors 120, which are configured to provide rotational power to the rollers 116. The motors 120 may provide sufficient power to draw the feedstock 134 through the CEFAS device 102 while maintaining uniaxial and shear forces to process the feedstock 134 and create the desired sintered products 135. In some embodiments, each motor 120 may be configured to rotate at different speeds which may create a mechanical shear in the feedstock 134 as it passes through the CEFAS device 102. In some embodiments, only one roller 116 may be connected to the motor 120.

The shafts 117 may be configured to guide the rotational motion of the rollers 116. A material of the shafts 117 may comprise one or more of high entropy alloy, nickel-based alloy, ferritic alloy, high strength composite, and/or fiber reinforced composite. The shafts 117 may be cooled by the liquid cooling system 114.

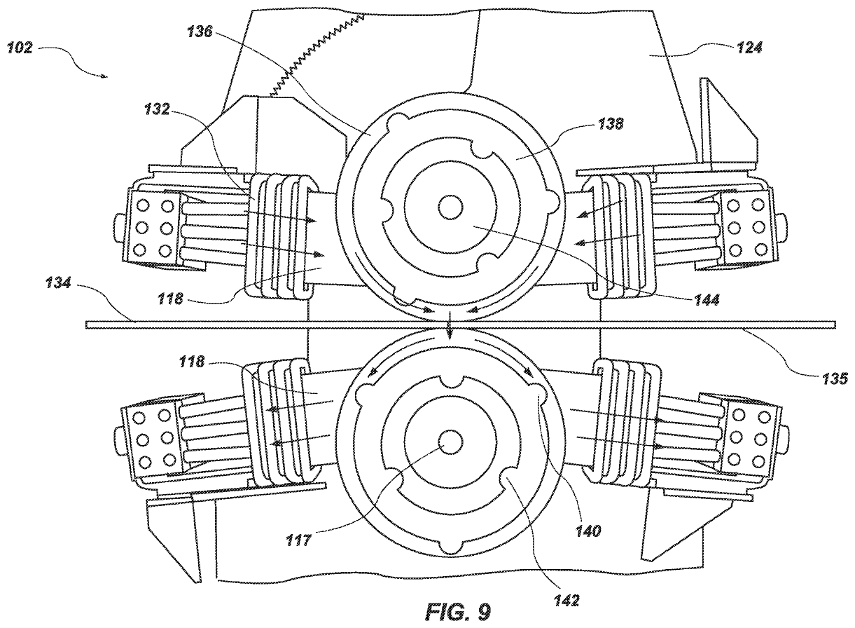

The brushes 118 may be secured to brush holders 124. The brushes 118 may be configured to interact with the rollers 116. The brushes 118 may be formed of and include graphite, carbon/carbon composites, fiber reinforced composites, refractory metals, or some combination thereof. Each roller 116 may be configured to interact with two brushes 118. The brushes 118 may be configured to pass an electrical current through the roller 116 to generate Joule heating or resistive heating of the feedstock. The electrical current may be configured to pass from one brush 118 to another brush 118 on the same roller (FIG. 5) or the electrical current may be configured to pass from one roller 116 to the other roller 116 (FIG. 9) or a combination thereof. Localized heating of the feedstock and the applied pressure result in sintering of the feedstock. In general, materials used in the CEFAS device 102 have an electrical resistivity that prevents about 100% of electrical energy being transmitted through the material. The energy is dissipated through resistive heating during the CEFAS process. The electrical current passed through the rollers 116 by the brushes 118 may be sufficient to produce the heat for the CEFAS process. The interaction between the brushes 118 and the rollers 116 may also provide some rotational force to the rollers 116. The brush holders 124 may be configured to hold the brushes 118 in position relative to the rollers 116. Each pair of brushes 118 may be oriented substantially on opposite sides of the rollers 116. The brush holders 124 may include positioning motors 126. The positioning motors 126 may be operatively connected to the brushes 118 and may be configured to adjust the position of the brushes 118 relative to the rollers 116. Each brush holder 124 may have its own independent positioning motor 126. The brushes 118 may be positioned at an angle α relative to line 127 (FIG. 5). A higher angle of the brushes 118 relative to the line 127 may correspond to the brushes 118 being closer to the feedstock 134 and each other. The proximity of the brushes 118 to the feedstock 134 may correspond to an increase in the operational temperature of the CEFAS device 102. For example, the operational temperature of the CEFAS device 102 increases as the angle a increases.

The positioning system 122 may include an actuator 128 and a beam 130. The actuator 128 may be operatively connected to the beam 130. The beam 130 may be operatively connected to two of the brush holders 124. The actuator 128 may be configured to control the position of one of the rollers 116 relative to the other roller 116. In an operational state, the actuator 128 may be extended such that a gap between the rollers 116 is less than the thickness of the feedstock. In the operational state, the rollers 116 may be in direct contact with the feedstock. The rollers 116 are configured to apply pressure (e.g., a shear force, a tangential force) to the feedstock 134. The actuator 128 is also configured to apply pressure (e.g., a uniaxial force) to the feedstock during use and operation of the CEFAS assembly 100. The pressure applied to the feedstock 134 during operation of the CEFAS device 102 may be within a range from about 0 MPa to about 60 MPa. In some embodiments the pressure applied to the feedstock 134 may be greater than 60 MPa.

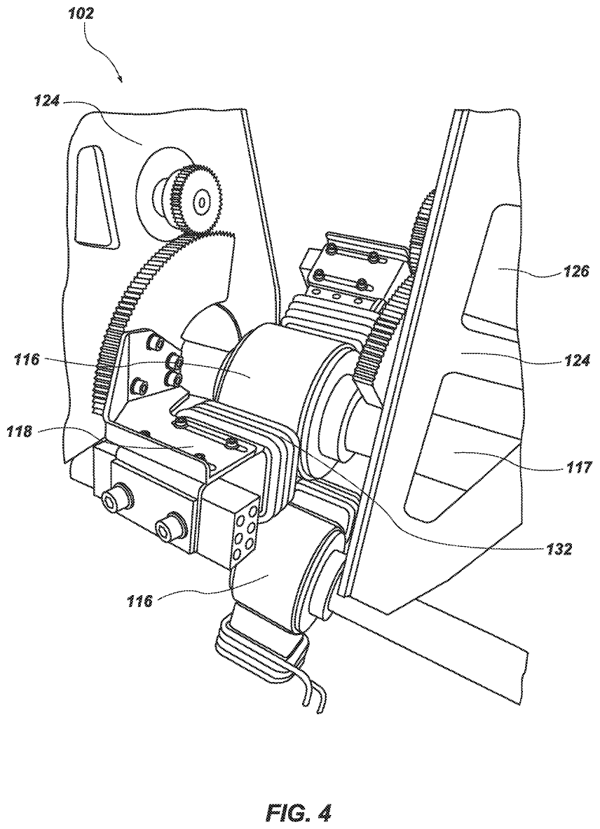

Referring to FIGS. 4 and 5, the brushes 118 may be surrounded by coils 132. The coils 132 may be a part of the liquid cooling system 114. The coils 132 may be formed of a thermally conductive material, such as copper, to facilitate heat transfer between the liquid cooling system 114 and the CEFAS device 102. In some embodiments, the liquid cooling system 114 may be integrated into the other components of the CEFAS device 102 through internal passageways.

FIG. 5 shows the CEFAS device 102 in an operational state, with the feedstock 134 being transported between the rollers 116 by the CEFAS process and produced into a sintered product 135. A space (e.g., an area) between the rollers 116 where sintering occurs may define a sintering space 125. The distance between the rollers 116 (i.e., the sintering space 125) may be within a range from about 0.1 mm to about 150 mm. The sintering space 125 may correspond to the thickness of the feedstock 134. For example, if the thickness of the feedstock is about 50 mm the space between the rollers 116 may be about 50 mm or less. An electric current flows from one brush 118 through the roller 116 and into another brush 118 positioned on an opposite side of the roller 116 as shown by the arrows. In some embodiments, the electrical current may be configured to pass from one roller 116, through the feedstock 134 and into the other roller 116 (see FIG. 9). The electrical current may facilitate heating the feedstock at a rate of about 1000 °C/min or more. The applied electrical current may cause resistive heating of the rollers 116. As shown in the embodiment in FIG. 5, the electrical current does not pass through the feedstock 134 but the feedstock 134 is heated through conductive heating from contact with the rollers 116. Referring to FIG. 9, in some embodiments, the electrical current may pass through the feedstock 134 and cause resistive heating of the feedstock 134. The feedstock 134 may be heated by conductive heating, resistive heating, or a combination thereof. The electric current applied to the CEFAS device 102 may range from about 1,000 amps (A) to about 50,000 A. In some embodiments, the electric current may range from about 2,000 A to about 40,000 A, from about 3,000 A to about 30,000 A, or from about 5,000 A to about 20,000 A. In some embodiments, the applied electrical current may be up to about 6000 Amps.

Referring to FIGS. 5-7, the roller 116 may include an outer ring 136 and an inner ring 138. The outer ring 136 may be configured to have an inner diameter that is slightly larger than the outer diameter of the inner ring 138. In some embodiments, the rollers have an outer diameter of about 12.7 cm and a width of about 7.6 cm. The dimensions of the rollers may be increased or decreased depending on the desired component being produced. The outer ring 136 may be formed of an electrically conductive material that is able to withstand high temperatures, such as the operating temperature of the CEFAS assembly 100. The outer ring 136 may have a substantially smooth outer surface 137. In some embodiments, the outer surface 137 may include one or more features that affect a final shape of the feedstock 134 during operation of the CEFAS device 102. In some embodiments, the outer ring 136 may be formed of and include graphite, carbon/carbon composites, or metallic alloys. The inner ring 138 may be formed of and include of an electrically insulative material to prevent electrical current from being passed to the motors 120. In some embodiments, the inner ring 138 is formed of a ceramic material such as, boron nitride, alumina, or cubic zirconia. Referring to FIG. 7, the inner ring 138 may comprise a shaft 139. The shaft 139 may include a disk 141 at each axial end of the shaft 139. The shaft 139 may have a smaller outer diameter than an outer diameter of the disks 141. The shaft 139 and the disks 141 may define a gap 143 therebetween. The gap 143 may be an air gap or may be configured to receive a thermally insulating material, such as graphite felt. The gap 143 may be configured to reduce heat transfer to the shafts 117 from the rollers 116. The outer ring 136 and the inner ring 138 may include a first series of fasteners 140. The first series of fasteners 140 may be configured to attach the outer ring 136 and the inner ring 138 relative to one another as the roller 116 rotates during operation of the CEFAS device 102. As shown in FIGS. 6 and 7, the outer ring 136 and the inner ring 138 include complementary recesses 147, 149. The recesses 147 in the outer ring 136 have substantially the same angular spacing as the recesses 149 in the inner ring 138. The fasteners 140 may be configured to be inserted into a cavity defined by the recesses 147, 149 when the recesses 147 in the outer ring 136 are substantially aligned with the recesses 149 in the inner ring 138, rotationally securing the outer ring 136 to the inner ring 138. The inner ring 138 may include a connection feature 142. The connection feature 142 may be configured to attach the inner ring 138 relative to a shaft 144 during operation of the CEFAS device 102. In some embodiments, the connection feature may include a second series of fasteners and associated complementary recesses. In some embodiments, the connection feature creates a mechanical interference to secure the inner ring 138 rotationally relative to the shaft 144. The shaft 144 is configured to transfer a rotational force from the motor 120 to the roller 116 during operation.

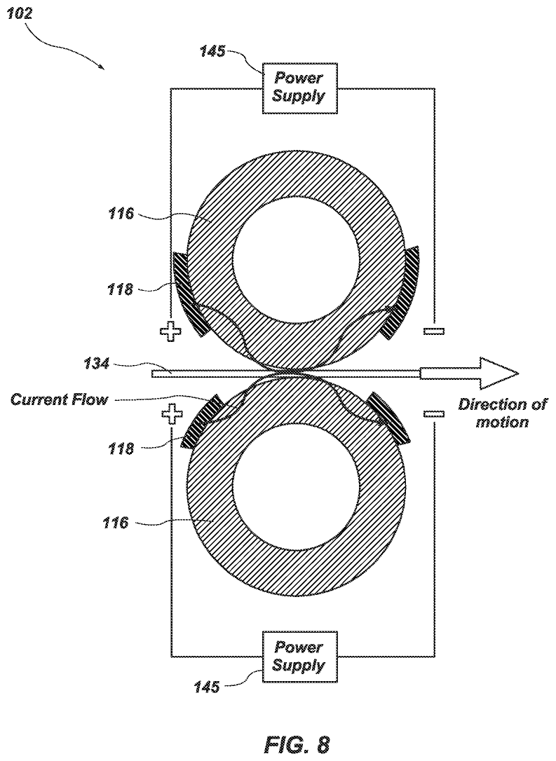

FIG. 8 shows an exemplary path for the electric current to flow from a power supply 145 and across (e.g., through) the rollers 116 of the CEFAS device 102 as shown by the lines labeled “current flow.” The current flow may pass from a brush 118 labelled with a “+,” into the roller 116, through the feedstock 134 along the direction of motion of the feedstock 134, back into the roller 116, and to a brush 118 labelled with a “−.” The current flow may pass from one roller 116, into the feedstock 134, and back into the same roller 116 or may pass from one roller, into the feedstock 134, and into the other roller 116. The power supply 145 is operatively connected to the brushes 118 of the CEFAS device 102. The power supply 145 may be a direct current (DC) power source such as a battery, rectifier, generator, or other DC power source. The brushes 118 are configured to pass the electrical current to the rollers 116 and the rollers 116 are in contact with the feedstock 134. The electrical current may heat the brushes 118, the rollers 116, and the feedstock 134 through resistive heating to facilitate the sintering process.

FIG. 8 also shows a direction of motion for the feedstock 134 through the rollers 116 when the CEFAS device is in an operational state.

FIG. 9 shows the CEFAS device 102 in another operational state, with a feedstock 134 being transported between the rollers 116 by the CEFAS process and turned into a sintered product 135. An electric current flows from one brush 118 through the roller 116 and into another roller 116 positioned on an opposite side of the feedstock 134 as shown by the arrows. The electrical current may facilitate resistive heating of the feedstock at a rate of about 1000 °C/min or more. The electrical current may cause resistive heating of the rollers 116 and the feedstock 134. The feedstock 134 may be heated by conductive heating, resistive heating, or a combination thereof. The electric current applied to the CEFAS device 102 may range from about 1,000 amps (A) to about 50,000 A. In some embodiments, the electric current may range from about 2,000 A to about 40,000 A, from about 3,000 A to about 30,000 A, or from about 5,000 A to about 20,000 A. In some embodiments, the applied electrical current may be up to about 6000 Amps.

The CEFAS device 102 may be configured to produce sintered products having a width of up to about 7.6 cm (3 inches), which is dependent on dimensions (e.g., a width) of the rollers 116. In some embodiments, the width and the diameter of the rollers 116 may be increased, facilitating the production of sintered products having a width greater than about 3 inches (7.62 centimeters). The sintered product produced by the CEFAS process according to embodiments of the disclosure may exhibit any desirable length as the feedstock 134 may be continuously fed into the CEFAS device 102, with the rollers 116 facilitating the production of any length of the sintered product. The sintered product according to embodiments of the disclosure may exhibit a geometry (e.g., length) that is not attainable by a conventional EFAS device. Therefore, the use of the CEFAS assembly 100 according to embodiments of the disclosure facilitates the production of sintered products that a conventional EFAS system could not produce due to physical limitations of the conventional EFAS devices. The CEFAS assembly 100 may also greatly reduce the production time of sintered products compared to using conventional EFAS systems for production of similar parts, such as between about 60% and about 98% reduction in production time. Using the CEFAS assembly 100 may result in a 200-fold reduction in production time and a significantly increased production rate. In some embodiments, the production time when using the CEFAS assembly 100 is reduced by as much as about 98% compared to that of the conventional EFAS system. In addition, the operation of the CEFAS assembly 100 according to embodiments of the disclosure may be at a 23-fold reduction in energy usage compared to the conventional EFAS system. The reduced production time, reduced energy usage, and increased production rate reduce energy costs associated with operating the CEFAS assembly 100.

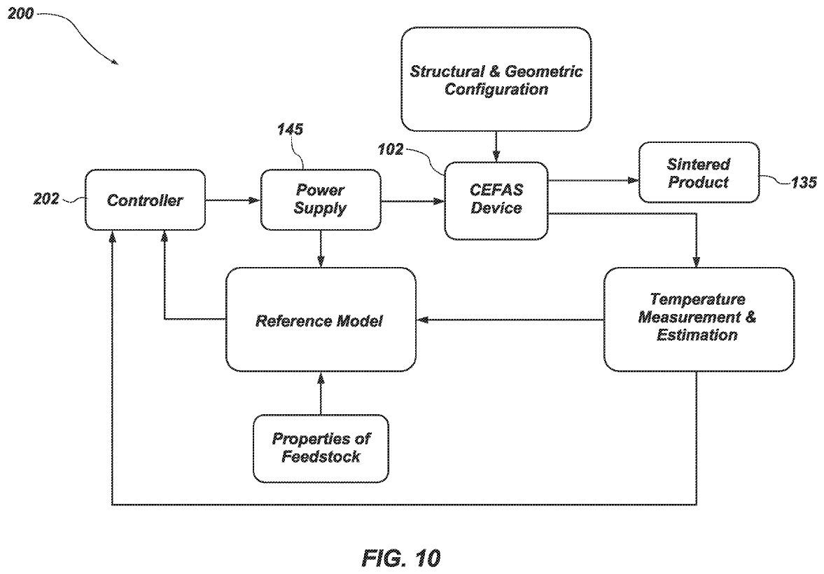

Referring to FIG. 10, the CEFAS assembly 100 may include a control system 200 that is configured to store instructions thereon that facilitate operation of the CEFAS device 102 and the enclosure 104. The instructions may include reference models that store information about the heating cycles of different materials and the threshold for which sintering may occur for a given material. The instructions may be stored on a controller 202 that is configured to communicate with the CEFAS device 102. The CEFAS device 102 may be configured to receive structural and geometric configuration information for the sintered product to be produced. The controller 202 may be configured to monitor the CEFAS device 102 and the enclosure 104 and provide temperature measurements and estimations based on the operating parameters of the CEFAS device 102, such as the electrical current across the rollers 116, feed rate of the feedstock 134, and the properties of the feedstock 134. The controller 202 may also provide alerts or facilitate changes to the production process. The controller 202 may allow for a user to make desired changes to the operation of the CEFAS device 102 or the enclosure 104. Alternatively, the controller 202 may be configured to make changes without the intervention of the user. In some embodiments, the controller 202 may apply machine learning, domain knowledge-based control parameters, and adaptive control algorithms to control the CEFAS device 102. The controller 202 may use information collected and stored from past production cycles and use machine learning, domain knowledge-based control parameters, and/or adaptive control algorithms to change the operating parameters of the CEFAS device 102.

A method for sintering the feedstock 134 using the CEFAS assembly 100 may include introducing the feedstock 134 through the inlet 106 of the enclosure 104. The feedstock 134 may be fed into the CEFAS device 102, between the rollers 116. In some embodiments, the CEFAS device 102 may draw the feedstock in without need for an external motor. In some embodiments, the rollers 116 and the brushes 118 may be placed in an operational position before the feedstock 134 is fed between the rollers 116. In other embodiments, the rollers 116 and the brushes 118 may be placed in an operational position after the feedstock 134 is fed between the rollers 116. Electrical current may be applied to the rollers 116 from one or more of the brushes 118. The electricity passes across the rollers 116 and generates heat, which in combination with the applied pressure through the rollers 116, sinters the feedstock 134. In some embodiments, the electrical current is passed from one roller 116 to another roller 116 and through the feedstock 134. In other embodiments, the electrical current is passed across the roller 116 from one brush 118 to another brush 118. Heat from the resistive heating of the rollers 116 and pressure from the positioning of the rollers 116 by the actuator 128 are applied to the feedstock 134 during operation of the CEFAS assembly 100. In some embodiments, the method for sintering the feedstock 134 may include removing at least a portion of the feedstock 134 through sublimation or melting while transferring heat to the feedstock 134 from the at least two rollers 116. The temperature at points of contact between the rollers 116 and the feedstock 134 may be up to about 1650 °C when the electric current passes across the roller as shown in FIG. 5. The temperature at points of contact between the rollers 116 and the feedstock 134 may be up to about 3000 °C when the electric current passes through the feedstock 134 as shown in FIG. 9. As the rollers 116 rotate, an additional portion of the feedstock 134 is drawn in to the inlet 106 and the sintered product 135 is passed into the outlet 108 and exits the enclosure 104. The temperature control systems may operate to keep the CEFAS device 102 at or below a desired temperature.

The sintered product 135 according to embodiments of the disclosure may, for example, be used in high temperature environments, such as in solid state batteries, rare earth element magnets, solid oxide electrolyte cells (SOEC), solid oxide fuel cells (SOFC), or other articles exposed to high temperatures. In some embodiments, a coating may be applied to the feedstock as the feedstock is sintered by the CEFAS device 102. The coating may provide extra protection for the sintered product 135 in the high temperature environment.

Non-limiting embodiments of the disclosure include:
Embodiment 1: A sintering device, comprising: at least two rollers spaced apart and defining a sintering space therebetween, each roller comprising an electrically conductive outer ring; and at least two brushes disposed on each of the at least two rollers and configured to pass an electric current through the electrically conductive outer rings of each of the at least two rollers.
Embodiment 2: The sintering device of embodiment 1, wherein the sintering space between the at least two rollers is within a range from about 0.1 mm to about 150 mm.
Embodiment 3: The sintering device of embodiments 1 or 2, wherein the at least two rollers each comprise an inner ring positioned radially inside the outer ring, the inner ring formed from an electrically insulative material.
Embodiment 4: The sintering device of embodiment 3, wherein the outer ring is rotationally secured to the inner ring.
Embodiment 5: The sintering device of embodiments 1 through 4, wherein a first roller of the at least two rollers is configured to rotate at a different speed from a second roller of the at least two rollers.
Embodiment 6: The sintering device of embodiments 1 through 5, wherein the electrically conductive outer ring comprises at least one of graphite, carbon, carbon composites, metallic alloys, or a combination thereof.
Embodiment 7: The sintering device of embodiments 1 through 6, wherein the electrically conductive outer ring has a smooth outer surface.
Embodiment 8: The sintering device of embodiments 1 through 7, wherein the at least two brushes are configured to pass electric current from a first roller of the at least two rollers, through a material in the sintering space, and to a second roller of the at least two rollers.
Embodiment 9: A sintering assembly comprising: a sintering device comprising; at least two rollers comprising an electrically conductive outer ring; and at least two brushes contacting the at least two rollers, the at least two brushes configured to pass an electric current through each electrically conductive outer ring; and an enclosure operatively connected to the sintering device, the at least two rollers of the sintering device configured to receive a feedstock from an inlet of the enclosure and configured to produce a sintered product to an outlet of the enclosure.
Embodiment 10: The sintering assembly of embodiment 9, further comprising a liquid cooling system operatively connected to the sintering device.
Embodiment 11: The sintering assembly of embodiment 9 or 10, further comprising a power supply operatively connected to the sintering device and configured to apply an electric current in a range of from about 1,000 A to about 50,000 A across the at least two rollers through the at least two brushes.
Embodiment 12: The sintering assembly of embodiments 9 through 11, wherein the enclosure is configured to continuously output the sintered product at the outlet.
Embodiment 13: The sintering assembly of embodiments 9 through 12 further comprising a control system configured to monitor parameters of the sintering device, the control system configured to adjust the parameters of the sintering device during operation of the sintering device.
Embodiment 14: A method of sintering a feedstock, comprising introducing a feedstock to a sintering device, the sintering device comprising: at least two rollers spaced apart and defining a sintering space therebetween, each roller comprising an electrically conductive outer ring; and at least two brushes disposed on each of the at least two rollers and configured to pass an electric current through the electrically conductive outer rings of each of the at least two rollers; continuously passing the feedstock into the sintering space between the at least two rollers of the sintering device, the at least two rollers positioned to contact the feedstock; applying an electric current across the at least two rollers through the at least two brushes, the electric current resistively heating the at least two rollers; and transferring heat to the feedstock from the at least two rollers to produce a sintered product.
Embodiment 15: The method of embodiment 14, wherein applying the electric current comprises applying the electric current through the at least two rollers without the electric current going through the feedstock.
Embodiment 16: The method of embodiment 14, wherein applying the electric current comprises applying the electric current through the at least two rollers and through the feedstock.
Embodiment 17: The method of embodiments 14 through 16, further comprising applying a pressure to the feedstock through the at least two rollers.
Embodiment 18: The method of embodiments 14 through 17, further comprising removing at least a portion of the feedstock through sublimation or melting while transferring heat to the feedstock from the at least two rollers.
Embodiment 19: The method of embodiments 14 through 18, further comprising: monitoring one or more parameters of the sintering device with a control system configured to facilitate operation of the sintering device; and comparing the one or more parameters to a reference model stored on a controller of the control system.
Embodiment 20: The method of embodiments 14 through 19, further comprising adjusting the one or more parameters of the sintering device during operation of the sintering device.

The embodiments of the disclosure described above and illustrated in the accompanying drawing figures do not limit the scope of the disclosure, since these embodiments are merely examples of embodiments of the disclosure, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, will become apparent to those of ordinary skill in the art from the description. Such modifications and embodiments also fall within the scope of the appended claims and their legal equivalents.

1. A sintering device, comprising:
at least two rollers spaced apart and defining a sintering space therebetween, each roller comprising an electrically conductive outer ring; and
at least two brushes disposed on each of the at least two rollers and configured to pass an electric current through the electrically conductive outer ring of each of the at least two rollers.

2. The sintering device of claim 1, wherein the sintering space between the at least two rollers is within a range from about 0.1 mm to about 150 mm.

3. The sintering device of claim 1, wherein the at least two rollers each comprise an inner ring positioned radially inside the electrically conductive outer ring, the inner ring formed from an electrically insulative material.

4. The sintering device of claim 3, wherein the electrically conductive outer ring is rotationally secured to the inner ring.

5. The sintering device of claim 1, wherein a first roller of the at least two rollers is configured to rotate at a different speed from a second roller of the at least two rollers.

6. The sintering device of claim 1, wherein the electrically conductive outer ring comprises at least one of graphite, carbon, carbon composites, metallic alloys, or a combination thereof.

7. The sintering device of claim 1, wherein the electrically conductive outer ring has a smooth outer surface.

8. The sintering device of claim 1, wherein the at least two brushes are configured to pass electric current from a first roller of the at least two rollers, through a material in the sintering space, and to a second roller of the at least two rollers.

9. A sintering assembly comprising:
a sintering device comprising:
at least two rollers comprising an electrically conductive outer ring; and
at least two brushes contacting the at least two rollers, the at least two brushes configured to pass an electric current through each electrically conductive outer ring; and
an enclosure operatively connected to the sintering device, the at least two rollers of the sintering device configured to receive a feedstock from an inlet of the enclosure and configured to produce a sintered product to an outlet of the enclosure.

10. The sintering assembly of claim 9, further comprising a liquid cooling system operatively connected to the sintering device.

11. The sintering assembly of claim 9, further comprising a power supply operatively connected to the sintering device and configured to apply an electric current in a range of from about 1,000 A to about 50,000 A across the at least two rollers through the at least two brushes.

12. The sintering assembly of claim 9, wherein the enclosure is configured to continuously output the sintered product at the outlet.

13. The sintering assembly of claim 9, further comprising a control system configured to monitor parameters of the sintering device, the control system configured to adjust the parameters of the sintering device during operation of the sintering device.

14. A method of sintering a feedstock, comprising:
introducing a feedstock to a sintering device, the sintering device comprising:
at least two rollers spaced apart and defining a sintering space therebetween, each roller comprising an electrically conductive outer ring; and
at least two brushes disposed on each of the at least two rollers and configured to pass an electric current through the electrically conductive outer ring of each of the at least two rollers;
continuously passing the feedstock into the sintering space between the at least two rollers of the sintering device, the at least two rollers positioned to contact the feedstock;
applying an electric current across the at least two rollers through the at least two brushes, the electric current resistively heating the at least two rollers; and
transferring heat to the feedstock from the at least two rollers to produce a sintered product.

15. The method of claim 14, wherein applying the electric current comprises applying the electric current through the at least two rollers without the electric current passing through the feedstock.

16. The method of claim 14, wherein applying the electric current comprises applying the electric current through the at least two rollers and through the feedstock.

17. The method of claim 14, further comprising applying a pressure to the feedstock through the at least two rollers.

18. The method of claim 14, further comprising removing at least a portion of the feedstock through sublimation or melting while transferring heat to the feedstock from the at least two rollers.

19. The method of claim 15, further comprising:
monitoring one or more parameters of the sintering device with a control system configured to facilitate operation of the sintering device; and
comparing the one or more parameters to a reference model stored on a controller of the control system.

20. The method of claim 19, further comprising adjusting the one or more parameters of the sintering device during operation of the sintering device.
